(19) United States
(12) Patent Application Publication
(10) Pub. No.: US 2016/0089299 A1
(43) Pub. Date: Mar. 31, 2016

(54) EDEMA THERAPY APPARATUS

(71) Applicant: Stefan Daniel Munoz, Austin, TX (US)

(72) Inventor: Stefan Daniel Munoz, Austin, TX (US)

(21) Appl. No.: 14/497,901

(22) Filed: Sep. 26, 2014

(51) Int. Cl. A61H 23/02

(52) U.S. Cl. CPC A61H 23/0263; A61H 2023/0272

(57) ABSTRACT

An edema therapy apparatus for the treatment and therapy of such conditions as edema, lymphedema, clotting and thrombosis. Apparatus is characterized by flexible wrap containing a plurality of vibration motors housed within a corresponding plurality of vibration motors mounts, all of which integrate into wrap. Vibration motors are inserted into vibration motor mounts allowing transfer of vibration from the motors themselves to the applied area. Vibration motors are connected by a wired circuit, which is coupled to a barrel plug adapter at an opposing end of the apparatus. Power is to be applied to the circuit containing the motors by a portable power supply housing a plurality of batteries to supply voltage. Function is control by way of an on-off switch located on the power supply.

### CROSS REFERENCE TO RELATED APPLICATIONS

Application references U.S. Provisional Patent Application No. 61/883,198, filed on Sep. 27, 2013, titled Edema Therapy Apparatus, applied for under inventor Stefan Munoz.

### STATEMENT REGARDING FEDERALLY SPONSORED RESEARCH OR DEVELOPMENT

Not applicable.

### REFERENCE TO SEQUENCE LISTING

Not applicable

### BACKGROUND OF THE INVENTION

The disclosure relates to a device providing vibration therapy and more particularly to a wrap for use on a portion of a human body to treat a patient having edema issues.

Patients often require treatment to reduce swelling and improve circulation and dexterity which often occurs in various parts of the human body. Thus, the treatment of edema can be enhanced by vibration therapy. It would be of benefit to provide an easy to carry wrap which can be applied to a patient's body along with a power supply so that relief can be available to a patient by means of a portable device.

### BRIEF SUMMARY OF THE INVENTION

An easy-to-carry portable wrap is provided for application to a selected portion of the human body, such as for example a portion of a limb or torso. The wrap includes an applicator pad and an elongated tensioning strap is attached to the pad. A portable power supply is provided. Vibrator units are carried by the pad and are connected to the power supply for causing vibration to the pad. The tensioning strap and the wrap can be secured to the selected portion of the human body.

### BRIEF SUMMARY OF THE SEVERAL VIEWS OF THE DRAWINGS

FIG. 1 is a planar view illustrating an embodiment of application side of the therapy apparatus.

FIG. 2 is a planar view illustrating an embodiment of an opposite side of therapy apparatus

FIG. 3 is a side elevational view illustrating embodiment therapy apparatus.

FIG. 4 is a exploded side elevational view illustrating an embodiment of a vibration motor mount removed from wrap.

FIG. 5 is a planar view illustrating an embodiment of a power supply.

### DETAILED DESCRIPTION OF THE INVENTION

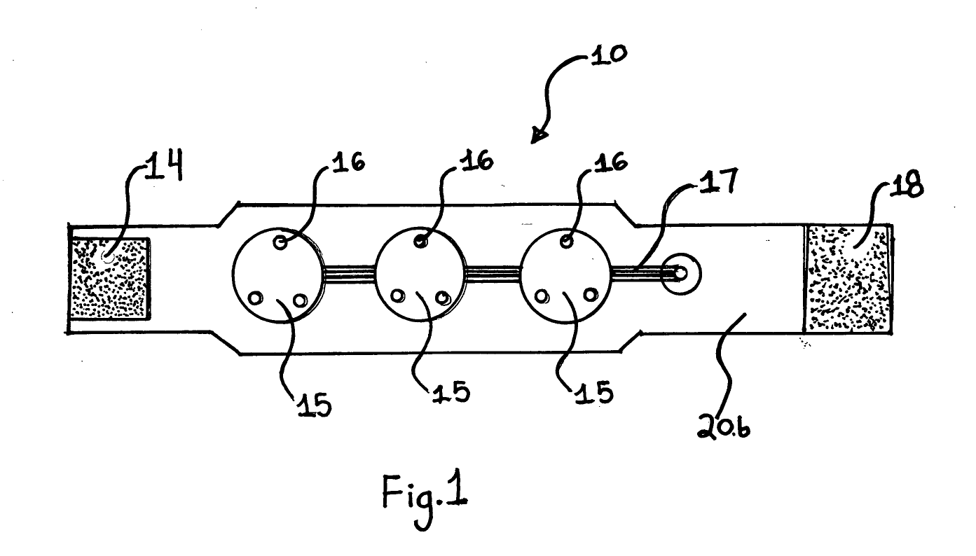

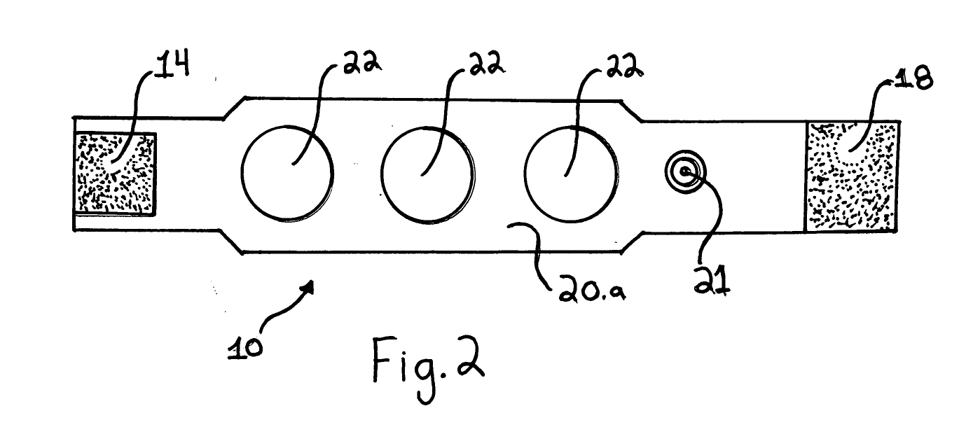

A wrap device 10, FIG. 1 is illustrated as having an applicator side 20b. Side 20b includes vibration motor mount 15. Vibration motor-mount 15 houses vibration motor and is pressed into side 20b of wrap 10. Vibration motor mount includes raised contact points 16. Wrap device 10 is formed of an flexible synthetic material and is generally rectangular. At one end of side 20b is an attached hook and loop pad 18 (hook side). The one end of wrap 10 with pad 18 (hook side) will wrap around limb, overlapping slightly allowing for pad 18 (hook side) be adjusted and secured to opposing hook and loop pad 14, see FIG. 2. Wrap 10 is of sufficient length to wrap around a human limb (not shown). The pad and strap arrangement described above can also be applied to a larger portion of a patient, e.g. torso, and if needed, an additional wrap device 10 can be joined with a first wrap device to accommodate a large circumference. On side 20b runs a 2 wire harness bridging the motors and forming a circuit to powered voltage.

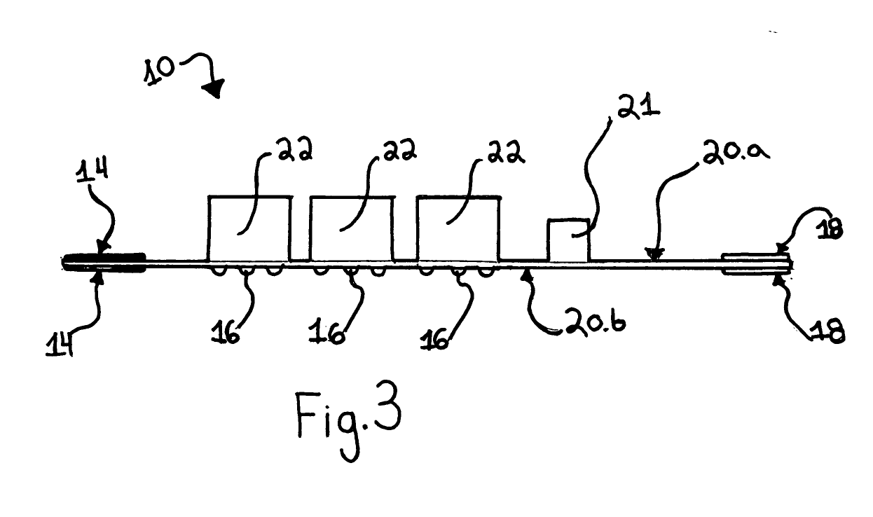

A second side 20a, FIG. 2, includes a plurality of enclosed vibrator devices 22, such as an eccentric mass vibration motor, which may be commercially available, or if necessary, may be custom constructed. In FIG. 2, three vibrators are illustrated but any number may be used as required. The vibrators 22 are connected to each other in series and ultimately connected to a power supply 24, see FIG. 3. The interconnection of the vibrators 22 is accomplished by a two-wire, harness 17, see FIG. 1. Power is provided to circuit by way of D/C barrel connector 21 molded into side 20a of wrap 10. At one end of side 20a, opposite the one end, is attached hook and loop pad 14 (loop side) In FIGS. 1, 2 and 3.

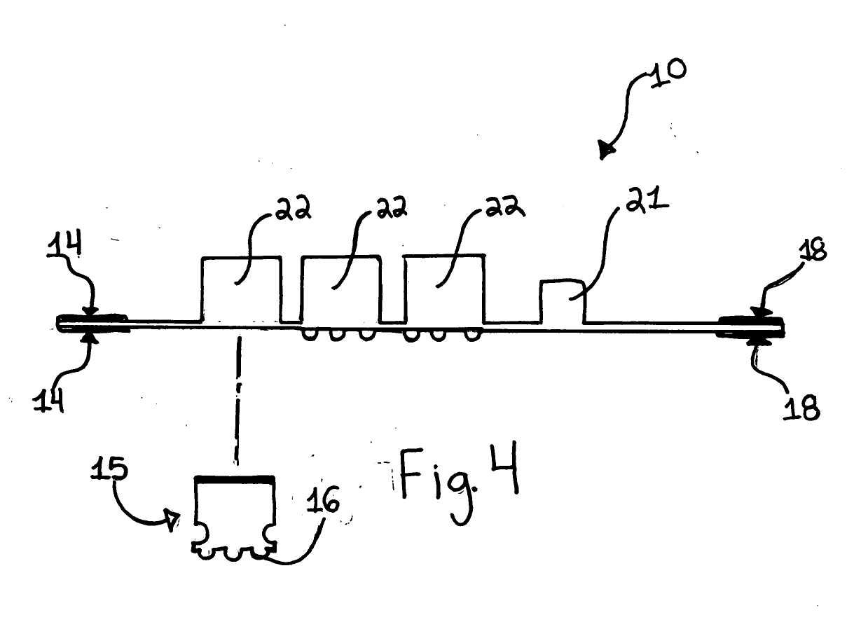

In FIGS. 1 and 4, a plastic mount 36 is provided for retaining the vibrating motors 22 and for securing vibrating motors into side 20b of wrap 10. Each one piece mount 15 includes a hollow upper portion for retaining vibrating motor 22, and a solid lower portion including contact point(s) 16. Contact point(s) 16 remain exposed beneath wrap 10 on side 20b, when secured into wrap 10, see FIGS. 1 and 4.

A power supply 1 also includes four AA Lithium batteries 8 FIG. 3, in a AA batter housing 11, and a push button single throw on/off toggle switch 14. A barrel plug 9 for coupling to and providing voltage at DC barrel connector 21.

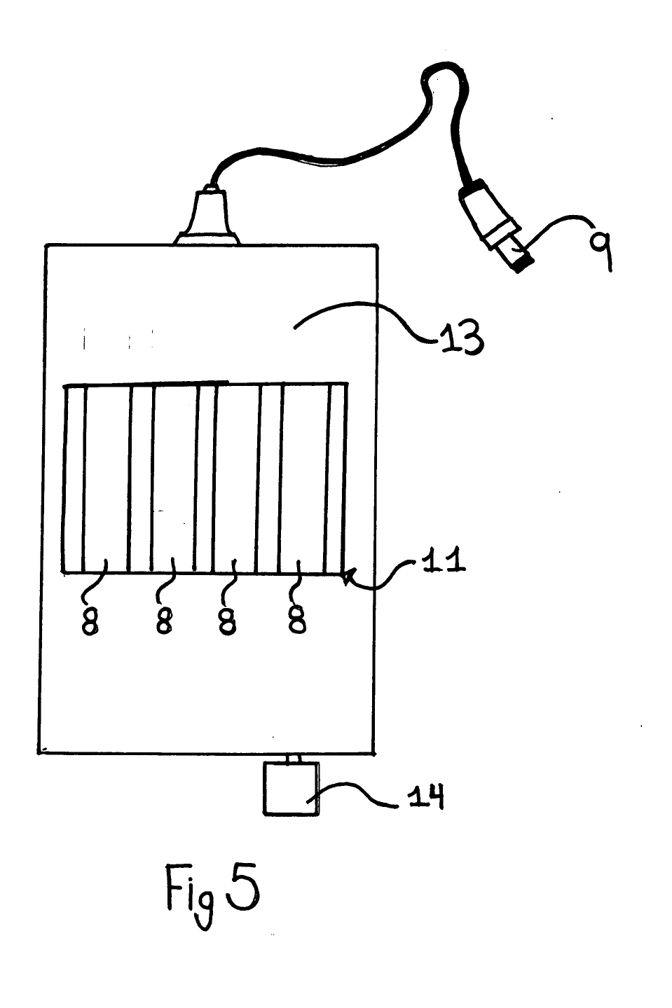

In operation, FIGS. 1-5, with the side 20b applied to limb having first side 12a including contact members 16 in contact with area to be treated. Switch 14 is actuated and power is supplied to vibrators 22 for a desired time period. Vibration is transferred through mount and its contact member 16 to the treated area to provide the desired relief. Alternatively, wrap 10, side 20b can be in the form of a closed flexible band rather than a rectangular pad. The band may be formed by attaching a first hook pad 18 of side 20b to a second loop end 14 of the wrap 10, side 20a, FIGS. 1 and 2. The band may be easily slipped on and off of a patient's limb for treating affected areas.

Although illustrative embodiments have been shown and described, a wide range of modification, change and substitution is contemplated in the foregoing disclosure and in some instances; some features of the embodiments may be employed without a corresponding use of other features. Accordingly, it is appropriate that the appended claims be construed broadly and in a manner consistent with the scope of the embodiments disclosed herein.

What is claimed is:

1. An lymphedema or edema therapy apparatus, comprising:
a flexible wrap provisioned for a plurality of vibration devices o be applied to a limb on the body;
a combination of hook and loop pads for joining one end of wrap to another opposite end, forming a closed loop once secured;
a plurality of vibration motors to generate a vibrating sensation sufficient to transfer to applied limb;
a plurality of vibration motor mounts to house vibration motors, said mounts integrating motors into wrap, whereby vibration is transferred to limb;
a circuit bridging the motors by which power can be transmitted when coupled to a power source;
a power supply to transmit voltage from battery array across wiring harness to power said circuit to which motors are wired; and
an on-off switch coupled to the power supply to control apparatus power function.
